(19) United States
(12) Patent Application Publication
(10) Pub. No.: US 2023/0181938 A1
(43) Pub. Date: Jun. 15, 2023

(54) WEARABLE AIR PURIFIER

(71) Applicant: Dyson Technology Limited, Wiltshire (GB)

(72) Inventors: Duncan Jack PATTULLO, Bristol (GB); Stephen Andrew BAKER, Swindon (GB); Simon Brian MCNAMEE, Bristol (GB); Luke Peter Edward PALMER, Swindon (GB); Christopher James HOLLOWAY, Swindon (GB)

(73) Assignee: Dyson Technology Limited, Wiltshire (GB)

(21) Appl. No.: 17/923,469

(22) PCT Filed: Mar. 11, 2021
(86) PCT No.: PCT/GB2021/050605

§ 371 Date: Nov. 4, 2022

(30) Foreign Application Priority Data
May 18, 2020 (GB) 2007318.5

(51) Int. Cl. A62B 18/00; A62B 7/10; A62B 18/02

(52) U.S. Cl. CPC A62B 18/006; A62B 7/10; A62B 18/025; A62B 18/003

(57) ABSTRACT

A wearable air purifier including a headgear; an air purifier assembly, the air purifier assembly configured to generate a filtered airflow from an outlet aperture thereof; and a nozzle assembly connected to the headgear by a hinge assembly. The nozzle assembly includes an inlet aperture for receiving the filtered airflow from the outlet aperture of the air purifier assembly and an air outlet for emitting the filtered airflow from the nozzle assembly. The hinge assembly is configured such that the nozzle assembly is movable relative to the headgear between first and second configurations, filtered airflow is emitted from the air outlet in the first configuration and filtered airflow is not emitted from the air outlet in the second configuration.

### FIELD OF THE INVENTION

The present invention relates to a wearable air purifier.

### BACKGROUND OF THE INVENTION

Air pollution is an increasing problem and a variety of air pollutants have known or suspected harmful effects on human health. The adverse effects that can be caused by air pollution depend upon the pollutant type and concentration, and the length of exposure to the polluted air. For example, high air pollution levels can cause immediate health problems such as aggravated cardiovascular and respiratory illness, whereas long-term exposure to polluted air can have permanent health effects such as loss of lung capacity and decreased lung function, and the development of diseases such as asthma, bronchitis, emphysema, and possibly cancer.

In locations with particularly high levels of air pollution, many individuals have recognised the benefits of minimising their exposure to these pollutants and have therefore taken to wearing face masks with the aim of filtering out at least a portion of the pollutants present in the air before it reaches the mouth and nose. There have also been various attempts to develop air purifiers that can be worn by the user but that do not require the wearer’s mouth and nose to be covered. For example, there are various designs for wearable air purifiers that are worn around the neck of the wearer and that create a jet of air that is directed upwards towards the wearer’s mouth and nose.

### SUMMARY OF THE INVENTION

According to a first aspect of the present invention there is provided a wearable air purifier comprising: a headgear; an air purifier assembly, the air purifier assembly configured to generate a filtered airflow from an outlet aperture thereof; and a nozzle assembly connected to the headgear by a hinge assembly, the nozzle assembly comprising an inlet aperture for receiving the filtered airflow from the outlet aperture of the air purifier assembly and an air outlet for emitting the filtered airflow from the nozzle assembly, wherein the hinge assembly is configured such that the nozzle assembly is movable relative to the headgear between first and second configurations, filtered airflow is emitted from the air outlet in the first configuration and filtered airflow is not emitted from the air outlet in the second configuration.

The wearable air purifier according to the first aspect of the present invention may be beneficial principally as the nozzle assembly is connected to the headgear by a hinge assembly, the hinge assembly is configured such that the nozzle assembly is movable relative to the headgear between first and second configurations, filtered airflow is emitted from the air outlet in the first configuration and filtered airflow is not emitted from the air outlet in the second configuration.

In particular, movement of the nozzle assembly between the first and second configurations may ensure that airflow is only emitted from the air outlet to a wearer of the wearable air purifier when the nozzle assembly is in the correct, for example the first, configuration. This may ensure that the air outlet is properly located relative to the wearer in order for delivery of filtered airflow to occur. Filtered airflow generated by the air purifier assembly may only be received by the inlet aperture of the nozzle assembly when the nozzle assembly is in the first configuration. Filtered airflow generated by the air purifier assembly may not received by the inlet aperture of the nozzle assembly when the nozzle assembly is in the first configuration.

The air purifier assembly may be supported by the headgear. The nozzle assembly may then be directly connected to the outlet apertures of the air purifier assembly by the hinges, such that the nozzle assembly is indirectly connected to the headgear. Alternatively, the nozzle assembly may be directly connected to the headgear by the hinges and fluidically connected to the outlet apertures of the air purifier assembly by ducting that is connected to the headgear.

The air outlet of the nozzle assembly may comprise a final component of the wearable air purifier through which filtered airflow travels before being emitted to a wearer. For example, there may be no components of the wearable air purifier downstream of the air outlet of the nozzle assembly through which filtered airflow passes in use, and filtered airflow may be emitted from the air outlet, and hence from the wearable air purifier, toward the mouth and nasal region of a wearer in use.

The nozzle assembly may be configured such that, with the wearable air purifier located on a head of a wearer, the nozzle assembly extends in front of a face of the wearer, for example such that the air outlet is located in a region of a mouth and/or lower nasal region of the wearer. The nozzle assembly may be configured such that the nozzle assembly extends in front of a face of the wearer without contacting the face of the wearer. This may provide an arrangement with increased comfort for the wearer, for example relative to an arrangement where the nozzle assembly contacts a face of a wearer in use. The nozzle assembly may be generally elongate and arcuate in form. The air outlet may be substantially centrally located along the nozzle assembly.

The inlet aperture of the nozzle assembly may be in fluidic communication with the outlet aperture of the air purifier assembly when the nozzle assembly is in the first configuration. For example, the air purifier assembly may be disposed within a housing, the outlet aperture may be formed in the housing, and the nozzle assembly may be connected to housing such that a perimeter of the inlet aperture is substantially coincident with a perimeter of the outlet aperture in the first configuration. The inlet aperture may be substantially aligned with the outlet aperture in the first configuration.

The inlet aperture of the nozzle assembly may not be in fluidic communication with the outlet aperture of the air purifier assembly when the nozzle assembly is in the second configuration. For example, the nozzle assembly may be connected to the housing such that the inlet aperture is spaced apart from the outlet aperture in the second configuration with a gap therebetween. There may be no further component connecting the inlet aperture and the outlet aperture in the second configuration. A perimeter of the inlet aperture may be at least partially misaligned, for example fully misaligned, with a perimeter of the outlet aperture in the second configuration.

The wearable air purifier may comprise a sensor for detecting when the nozzle assembly is in the second configuration, and a controller for controlling operation of the air purifier assembly to generate the filtered airflow in response to sensor data received from the sensor, and the controller may be configured to inhibit operation of the air purifier assembly when the nozzle assembly is in the second configuration. This may be beneficial as it may enable operation of the air purifier assembly to be stopped when the nozzle assembly is in the second configuration, which may conserve energy and prevent wastage of filtered airflow. For example, the air purifier assembly may comprise an airflow generator controlled by the controller, and operation of the airflow generator may be stopped by the controller when the sensor data indicates that the nozzle assembly is in the second configuration. This may reduce a draw on a power source of the airflow generator.

The sensor for detecting when the nozzle assembly is in the second configuration may comprise any of a proximity sensor and a contact sensor. For example, the purifier assembly housing may comprise a proximity sensor, the nozzle assembly may comprise an object detectable by the proximity sensor, and the sensor data may comprise a measurement of a property that is indicative of a distance of the object relative to the proximity sensor. The second configuration may be determined where a measurement of the property by the proximity sensor exceeds a pre-determined threshold. The pre-determined threshold may comprise a value for the property that is indicative of a point of separation between the nozzle assembly and the purifier assembly housing, for example a value for the property that is indicative of a distance at which a portion of the nozzle assembly can no longer be determined to be in contact with the purifier assembly housing. The sensor may comprise a hall sensor, and the object may comprise a magnet.

The wearable air purifier may comprise a sensor for detecting when the nozzle assembly is in the first configuration, and a controller for controlling operation of the air purifier assembly to generate the filtered airflow in response to sensor data received from the sensor, and the controller may be configured to only operate the air purifier assembly when the nozzle assembly is in the first configuration. This may be beneficial as it may ensure generation of the filtered airflow only where the nozzle assembly is in the first configuration. For example, the air purifier assembly may comprise an airflow generator controlled by the controller, and operation of the airflow generator may only be enabled by the controller when the sensor data indicates that the nozzle assembly is in the first configuration. This may reduce a draw on a power source of the airflow generator.

The sensor for detecting when the nozzle assembly is in the first configuration may comprise the same sensor as the sensor for detecting when the nozzle assembly is in the second configuration, and the controller. The controller may control operation of the air purifier assembly to re-start generation of the filtered airflow automatically in response to sensor data indicating a return to the first configuration from the second configuration, or may require a user input to re-start filtered airflow generation.

The wearable air purifier may comprise a speaker assembly and a speaker controller, and the speaker controller may be configured to operate the speaker assembly in a first mode when the nozzle assembly is in the first configuration, and in a second mode when the nozzle assembly is in the second configuration. For example, the speaker controller may operate the speaker assembly to provide audio output and/or noise cancellation in the first mode, and may operate the speaker assembly to pause or stop audio output and/or noise cancellation in the second mode. This may provide power saving by only operating the speaker assembly to provide audio output and/or noise cancellation when the nozzle assembly is in the first configuration.

The nozzle assembly is connected to the headgear by the hinge assembly such that the nozzle assembly moves away from the headgear when moving from the first configuration to the second configuration, for example via a pivoting/rotational motion. The nozzle assembly may move away from the headgear when moving from the first configuration to the second configuration such that an angle formed between the nozzle assembly and the headgear increases during the motion. For example, the nozzle assembly may move in a generally downward direction relative to a head of a wearer when moving from the first configuration to the second configuration. Thus the nozzle assembly may be dipped relative to the headgear when moving from the first configuration to the second configuration. This may be beneficial as it may enable a wearer to dip the nozzle assembly to allow visibility of their mouth and nasal region, for example to aid with talking, whilst ensuring that filtered airflow is not emitted from the nozzle assembly. The hinge assembly may be arranged such that the nozzle assembly is movable relative to the headgear in a plane parallel to a sagittal plane of a wearer in use.

The nozzle assembly may be retained in the first configuration by a detent, for example a detent that is wearer actuable to cause release of the nozzle assembly for motion between the first and second configurations. This may be beneficial as it may ensure that the nozzle assembly is only released from the first configuration when a wearer chooses to do so. The detent may retain the nozzle assembly in the first configuration with sufficient force such that the nozzle assembly does not move relative to the headgear under the force of filtered airflow received by the nozzle assembly in use.

The detent may be located above the hinge assembly when the headgear is worn by a wearer and the nozzle assembly is in the first configuration. This may assist with motion of the nozzle assembly in a generally downward motion relative to the wearer from the first configuration to the second configuration.

The detent may comprise a first magnetic element, for example a magnet, and a second magnetic element, for example a magnet, that cooperates with the first magnetic element to releasably retain the nozzle assembly in the first configuration. This may be beneficial as magnetic attachments may allow the wearer to move the nozzle assembly between the first and second configuration merely by applying an appropriate force to the nozzle assembly (e.g. pulling down or pushing up) and may provide a relatively strong yet inexpensive form of attachment. The first magnetic element may comprise a magnet and the second magnetic element may comprise a magnetic material, or vice versa. The first magnetic element may be disposed on the nozzle assembly. The second magnetic element may then be fixedly supported by the headgear. The second magnetic element may be disposed on the headgear itself, or may be supported by the headgear indirectly. In particular, the second magnetic element may be disposed on another component supported by the headgear. For example, the air purifier assembly may comprise an air purifier housing that is supported by the headgear, and the second magnetic element may then be disposed on the air purifier.

The detent may comprise a catch and a catch keeper that cooperates with the catch to releasably retain the nozzle assembly in the first configuration. Such an arrangement may provide a simple mechanical connection which may be easily releasable by a wearer in use. One of the catch and the catch keeper may be provided on the nozzle assembly. The other of the catch and the catch keeper may then be fixedly supported by the headgear. The other of the catch and the catch keeper may be disposed on the headgear itself, or may be supported by the headgear indirectly. In particular, the other of the catch and the catch keeper may be disposed on another component supported by the headgear. For example, the air purifier assembly may comprise an air purifier housing that is supported by the headgear, and the other of the catch and the catch keeper may then be disposed on the air purifier housing.

The hinge assembly may comprise first and second portions rotatably connected to one another, the first portion fixedly connected to one of the nozzle assembly and the headgear, and the second portion releasably connected to the other of the headgear and the nozzle assembly. This may be beneficial as it may enable separation of the nozzle assembly from the headgear, which may, for example, allow for ease of cleaning of the nozzle assembly. The releasable connection may, for example, comprise a magnetic connection.

A rotational extent of the hinge assembly may be limited such that motion of the nozzle assembly relative to the headgear about the hinge assembly is limited. This may, for example, inhibit the nozzle assembly from swinging freely relative to the headgear and inadvertently contacting a user.

The nozzle assembly may comprise a first end connected to a first end of the headgear by a first hinge, and a second opposite end connected to a second opposite of the headgear by a second hinge. Thus the first and second ends of the nozzle assembly may be movable during movement between the first and second configurations. The first and second hinges may each comprise respective first and second portions rotatably connected to one another, as described above. Each of the first and second hinges may have a corresponding detent, for example such that the nozzle assembly may be retained in the first configuration by first and second detents.

The first end of the nozzle assembly may comprise a first inlet aperture, for example the inlet aperture previously described, and the second end of the nozzle assembly may comprise a second inlet aperture.

The nozzle assembly may be directly or indirectly connected to the first and second ends of the headgear. The air purifier assembly may comprise a first housing portion connected to the first end of the headgear and a second housing portion connected to the second end of the headgear. The first end of the nozzle assembly may then be connected to the first housing portion of the air purifier assembly by the first hinge and the second end of the nozzle assembly connected to the second housing portion of the air purifier assembly by the second hinge. The air purifier assembly may comprise a first airflow generator and a first filter assembly for providing a first filtered airflow, and a second airflow generator and a second filter assembly for providing a second filtered airflow, the first airflow generator and the first filter assembly being disposed within the first and the second airflow generator and the second filter assembly being disposed within the second housing portion/

The air purifier assembly may comprise a first airflow generator and a first filter for providing a first filtered airflow to the first end of the nozzle assembly, and the air purifier assembly may comprise a second airflow generator and a second filter for providing a second filtered airflow to the second end of the nozzle assembly. This may be beneficial as first and second airflow generators may be individually smaller in size than a single airflow generator that is capable of delivering the same total airflow and may provide increased control over filtered airflow provided to a wearer in use, for example with each airflow generator being individually controlled. As described above, the first airflow generator and the first filter assembly may be supported at the first end of headgear, and the second airflow generator and the second filter assembly supported at the second opposite end of headgear.

According to a second aspect of the present invention there is provided a wearable air delivery apparatus comprising a headgear; and a nozzle assembly comprising an inlet aperture for receiving a filtered airflow from an air purifier assembly, and an air outlet for emitting the filtered airflow from the nozzle assembly; the nozzle assembly connected to the headgear by a hinge assembly such that the nozzle assembly is movable between first and second configurations relative to the headgear wherein the filtered airflow is emitted from the air outlet in the first configuration in use, and the filtered airflow is not emitted from the air outlet in the second configuration.

According to a third aspect of the present invention there is provided a wearable air purifier comprising: a headgear; an air purifier assembly, the air purifier configured to generate a filtered airflow; and a nozzle assembly comprising an inlet aperture for receiving the filtered airflow from the air purifier assembly, and an air outlet for emitting the filtered airflow from the nozzle assembly; wherein the nozzle assembly is rotatably connected to the headgear by a hinge assembly and the wearable air purifier comprises a releasable detent that inhibits rotation of the nozzle assembly relative to the headgear until the detent is released.

The wearable air purifier according to the third aspect of the present invention may be beneficial principally as the nozzle assembly is rotatably connected to the headgear by a hinge assembly and the wearable air purifier comprises a releasable detent that inhibits rotation of the nozzle assembly relative to the headgear until the detent is released. In particular, the releasable detent may ensure correct retention of the nozzle assembly relative to the air headgear in use, until released by a wearer. Once released by a wearer, the nozzle assembly may be rotatable relative to the headgear, which may enable a wearer to move the nozzle assembly in use, for example to a position in which a mouth of the wearer is not occluded, which may aid with talking.

The nozzle assembly may be connected to the headgear by the hinge assembly such that the nozzle assembly moves away from the headgear from a first configuration to a second configuration when the detent is released.

The nozzle assembly may be movable relative to the headgear in a plane parallel to a sagittal plane of a wearer in use.

The detent may be located above the hinge assembly when the headgear is worn by a wearer.

The detent may comprise a first magnetic element and a second magnetic element that cooperates with the first magnetic element to releasably inhibit rotation of the nozzle assembly relative to the headgear.

The detent may comprise a catch and a catch keeper that cooperates with the catch to releasably inhibit rotation of the nozzle assembly relative to the headgear.

The hinge assembly may comprise first and second portions rotatably connected to one another, the first portion fixedly connected to one of the nozzle assembly and the headgear, and the second portion releasably connected to the other of the headgear and the nozzle assembly.

A rotational extent of the hinge assembly may be limited such that motion of the nozzle assembly relative to the headgear about the hinge assembly is limited.

The nozzle assembly may comprise a first end connected to a first end of the headgear by a first hinge, and a second opposite end connected to a second opposite end of the headgear by a second hinge.

The air purifier assembly may comprise a first airflow generator and a first filter for providing a first filtered airflow to a first end of the nozzle assembly, and the air purifier assembly may comprise a second airflow generator and a second filter for providing a second filtered airflow to a second end of the nozzle assembly.

The wearable air purifier may comprise a speaker assembly and a speaker controller, and the speaker controller may be configured to operate the speaker assembly in a first mode when the nozzle assembly is in the first configuration, and in a second mode when the nozzle assembly is in the second configuration.

The wearable air purifier may comprise a sensor for detecting when the nozzle assembly is in the second configuration, and a controller for controlling operation of the air purifier assembly to generate the filtered airflow in response to sensor data received from the sensor, the controller configured to inhibit operation of the air purifier assembly when the nozzle assembly is in the second configuration.

The wearable air purifier may comprise a sensor for detecting when the nozzle assembly is in the first configuration, and a controller for controlling operation of the air purifier assembly to generate the filtered airflow in response to sensor data received from the sensor, the controller configured to only operate the air purifier assembly when the nozzle assembly is in the first configuration.

According to a fourth aspect of the present invention there is provided a wearable air delivery apparatus comprising a headgear; and a nozzle assembly comprising an inlet aperture for receiving a filtered airflow from an air purifier assembly, and an air outlet for emitting the filtered airflow from the nozzle assembly; wherein the nozzle assembly is rotatably connected to the headgear by a hinge assembly and the wearable air purifier comprises a releasable detent that inhibits rotation of the nozzle assembly relative to the headgear until the detent is released.

According to a fifth aspect of the present invention there is provided a wearable air delivery apparatus comprising a headgear; and a nozzle assembly comprising an inlet aperture for receiving an airflow, and an air outlet for emitting the airflow from the nozzle assembly; the nozzle assembly having a releasable connection to the headgear that when released allows the nozzle assembly to be at least partially separated from the headgear.

The wearable air delivery apparatus may comprise a sensor for detecting when the nozzle assembly is at least partially separated from the headgear. The sensor may be configured to provide an indication when the sensor detects that the nozzle assembly is at least partially separated from the headgear. This indication may comprise generating a corresponding output. The sensor may be configured to detect when the nozzle assembly is fully connected to the headgear. The sensor may be configured to provide an indication when the sensor detects that the nozzle assembly is fully connected to the headgear. This indication may comprise generating a corresponding output. The sensor may comprise a proximity sensor for detecting proximity of a portion of the nozzle assembly to the headgear. Alternatively, the sensor may comprise a contact sensor for detecting contact between a portion of the nozzle assembly and the headgear.

Preferential features of aspects of the present invention may be equally applied to other aspects of the present invention, where appropriate.

### BRIEF DESCRIPTION OF THE DRAWINGS

Embodiments of the invention will now be described, by way of example only, with reference to the accompanying drawings, in which:

FIG. 1 is a schematic front view of a wearable air purifier according to the present invention;

FIG. 2 is a schematic rear underside view of the wearable air purifier of FIG. 1;

FIG. 3 is a cross-sectional view of the wearable air purifier of FIG. 1 with a nozzle assembly removed;

FIG. 4 is a schematic upper front view of the wearable air purifier of FIG. 1 with the nozzle assembly detached;

FIG. 5 is a schematic side view of the wearable air purifier of FIG. 1 with the nozzle assembly in a first configuration;

FIG. 6 is a schematic side view of the wearable air purifier of FIG. 1 with the nozzle assembly in a second configuration;

FIG. 7a is a schematic view of a first embodiment of a connector portion of a nozzle assembly in accordance with the present invention;

FIG. 7b is a schematic view of a second embodiment of a connector portion of a nozzle assembly in accordance with the present invention;

FIG. 7c is a schematic view of a third embodiment of a connector portion of a nozzle assembly in accordance with the present invention; and

FIG. 7d is a schematic view of a fourth embodiment of a connector portion of a nozzle assembly in accordance with the present invention.

### DETAILED DESCRIPTION OF THE INVENTION

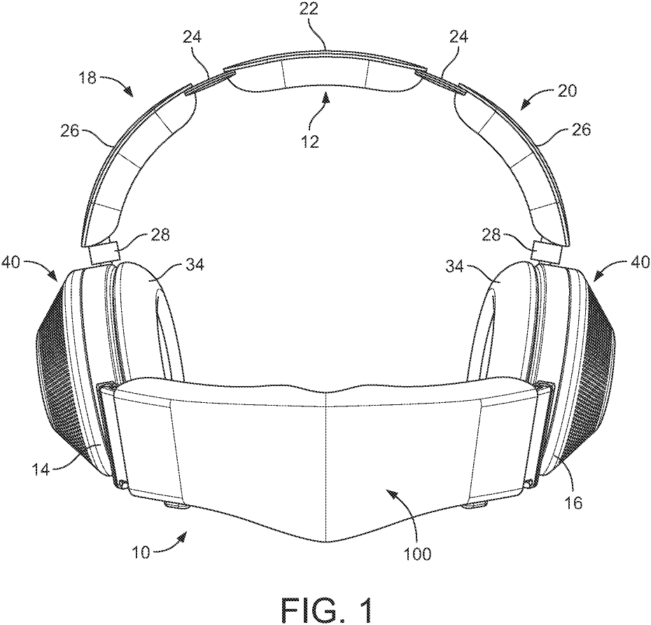

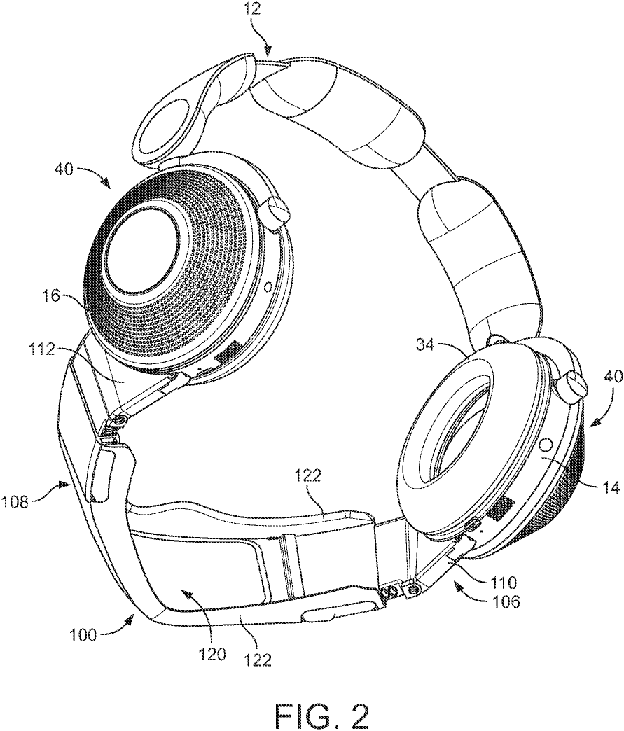

A wearable air purifier, generally designated 10, is shown schematically in FIGS. 1 and 2.

The wearable air purifier 10 comprises a headgear 12, 14, 16, an air purifier assembly 42, 44, and a nozzle assembly 100.

The headgear has the form of headphones and comprises a headband 12 and first 14 and second 16 housings connected to respective ends of the headband 12. The headband 12 is generally elongate and arcuate in form, and is configured to overlie a top of a head of a wearer, and sides of the head of the wearer, in use. The first 14 and second 16 housings then comprise ear cups such as those typically used for so-called “over-the-ear” headphones, which are generally hemispherical and hollow in form.

The headband 12 has a first end portion 18, a second end portion 20, and a central portion 22. Each of the first 18 and second 20 end portions are connected to the central portion 22 by an extension mechanism. Each extension mechanism comprises an arm 24 that engages with teeth internal of the first 18 and second 20 end portions to form a ratchet mechanism that enables adjustment of the length of the headband 12 by a wearer. To this end, the teeth, a spacing between the teeth and an opposing wall, or the arm 24 itself, may be sufficiently resilient to provide the required retention.

The first 18 and second 20 end portions of the headband 12 each comprise a hollow housing 26. The hollow housing 26 defines a battery compartment for receiving one or more batteries therein. It will be appreciated that batteries may be removable from the hollow housing 26, or may be intended to be retained within the hollow housing 26 during normal use. Where the batteries are replaceable and intended to be removable from the hollow housing 26, the hollow housing 26 may, for example, comprise a releasable door or cover to enable access to the interior of the hollow housing 26. Where batteries are rechargeable and intended to be retained within the hollow housing 26 in normal use, the hollow housing 26, or indeed other components of the wearable air purifier 10, may comprise at least one charge port to enable recharging of batteries.

The first 18 and second 20 end portions of the headband 12 are connected to respective ones of the first 14 and second 16 housings. In some examples, the first 18 and second 20 end portions of the headband 12 are connected to respective ones of the first 14 and second 16 housings such that relative movement is enabled between the first 18 and second 20 end portions of the headband 12 and the respective first 14 and second 16 housings. As shown in FIG. 1, a swivel pin 28 is used for such a connection, but it will be appreciated by a person skilled in the art that other forms of connection are possible. To enable electrical connection of batteries contained within the hollow housings 26 of the first 18 and second 20 end portions of the headband to components internal of the first 14 and second 16 housings, the swivel pins 28 are hollow, for example to allow electrical wiring or the like to pass therethrough.

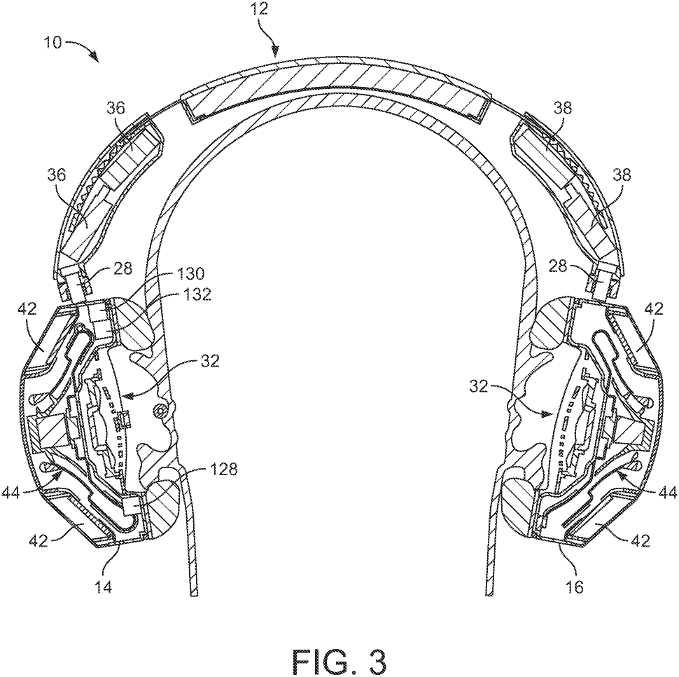

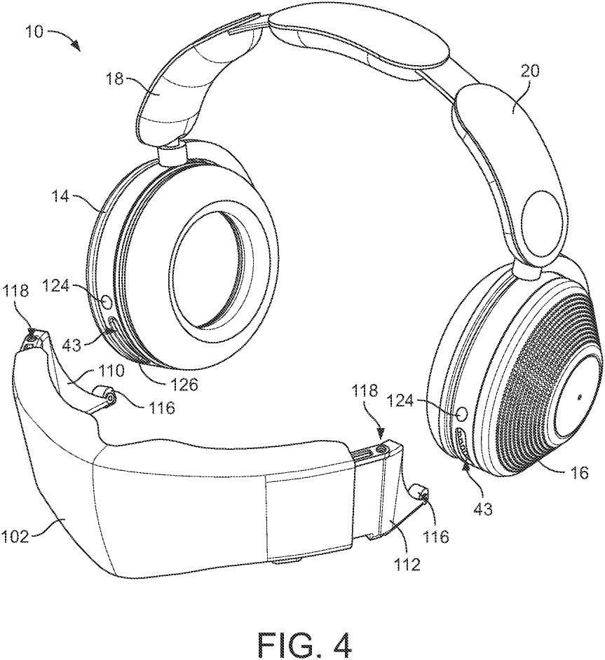

Each housing 14, 16 houses a speaker assembly 32, as shown in FIG. 3, and comprises annular padding 34 configured to surround an ear of a wearer of the wearable air purifier 10. Details of the speaker assembly 32 are not pertinent to the present invention, and so will not be described here for the sake of brevity, but it will be recognised by a person skilled in the art that any appropriate speaker assembly may be chosen. In use, the speaker assemblies 32 received within the first 14 and second 16 housings are configured to receive power from all of the batteries 36, 38. Power transfer wiring (not shown) runs through the headband 12 between the first 18 and second 20 end portions, for example through the central portion 22 and arms 24. Such an arrangement provides increased flexibility in power distribution between the speaker assemblies 32. In other embodiments the speaker assemblies 32 received within the first 14 and second 16 housings may be configured to receive power from batteries 36, 38 disposed in respective ones of the first 18 and second 20 end portions of the headband 12. For example, a speaker assembly 32 received within the first housing 14 may be configured to be powered by the batteries 36 within the first end portion 18 of the headband 12, whilst a speaker assembly 32 received within the second housing 16 may be configured to be powered by batteries 38 within the second end portion 20 of the headband 12.

As shown in FIG. 3, the first 14 and second 16 housings of the headgear further house filter assemblies 42 and airflow generators 44 of the air purifier assembly. Each housing 14, 16 then also provides ambient air inlets 40and outlet apertures 43 for the air purifier assembly.

The ambient air inlet 40 provided by each of the first 14 and second 16 housings comprises a plurality of apertures through which air may be drawn into the interior of the housing 14, 16 by the respective airflow generator 44. Each filter assembly 42 is disposed within a respective housing 14, 16 between the ambient air inlet 40 and a respective airflow generator 44. Each filter assembly 42 comprises one or more filter materials chosen to provide a desired degree of filtration of air to be provided to a wearer in use.

The airflow generators 44 each comprise a motor driven impeller which draws air from the respective ambient air inlet 40, through the respective filter assembly 42, and outputs air through the respective outlet aperture 43 of the air purifier assembly that is provided by the respective housing 14, 16. The airflow generators 44 in the first 14 and second housings 16 are configured to receive power from all of the batteries 36, 38. Power transfer wiring (not shown) runs through the headband 12 as described above in relation to the speaker assemblies 32. In other embodiments, the airflow generator 44 within first housing 14 may be configured to be powered by batteries 36 within the first end portion 18 of the headband 12, whilst the airflow generator 44 in the second housing 16 may be configured to be powered by batteries 38 within the second end portion 20 of the headband 12.

The nozzle assembly 100 comprises a conduit 102 having first 106 and second 108 ends. The conduit is curved between the first 106 and second 108 ends such that the conduit 102 is generally arcuate in form. The first 106 and second 108 ends comprise respective first 110 and second 112 connector portions that connect to respective ones of the first 14 and second 16 housings of the headgear, as will be described in more detail hereafter. When the nozzle assembly 100 is connected to the first 14 and second 16 housings, and the wearable air purifier 10 is worn by a wearer, the nozzle assembly 100 is configured to extend in front of the face of the wearer, particularly the mouth and lower nasal region of the wearer, without contacting the face of the wearer.

The conduit 102 has an air outlet 120 that is provided by a plurality of apertures distributed across an air outlet region of the nozzle assembly 100, which as shown is defined by a mesh. Upper and lower surfaces of the conduit 102 comprise flow guides 122 that extend rearwardly, for example toward a void defined between the first 110 and second 112 connector portions, and act to guide filtered airflow emitted from the nozzle assembly 100 toward a mouth and nasal region of a face of a wearer in use. It is envisaged that the flow guides 122 may be formed of a resiliently deformable material to allow for some deformation of the conduit 102 and such that wearer comfort is provided in the event of accidental contact with a face of a wearer in use.

The connector portions 110, 112 have curved ends that are curved to match an outer surface of the first 14 and second 16 housings. The first 110 and second 112 connector portions are generally hollow, and have inlet apertures 114 which are configured to be in direct fluid communication with outlet apertures 43 provided by the first 14 and second 16 housings when the nozzle assembly 100 is connected to the first 14 and second 16 housings respectively and in a first configuration. For example, there may be no components intermediate the outlet apertures 43 and the inlet apertures 114.

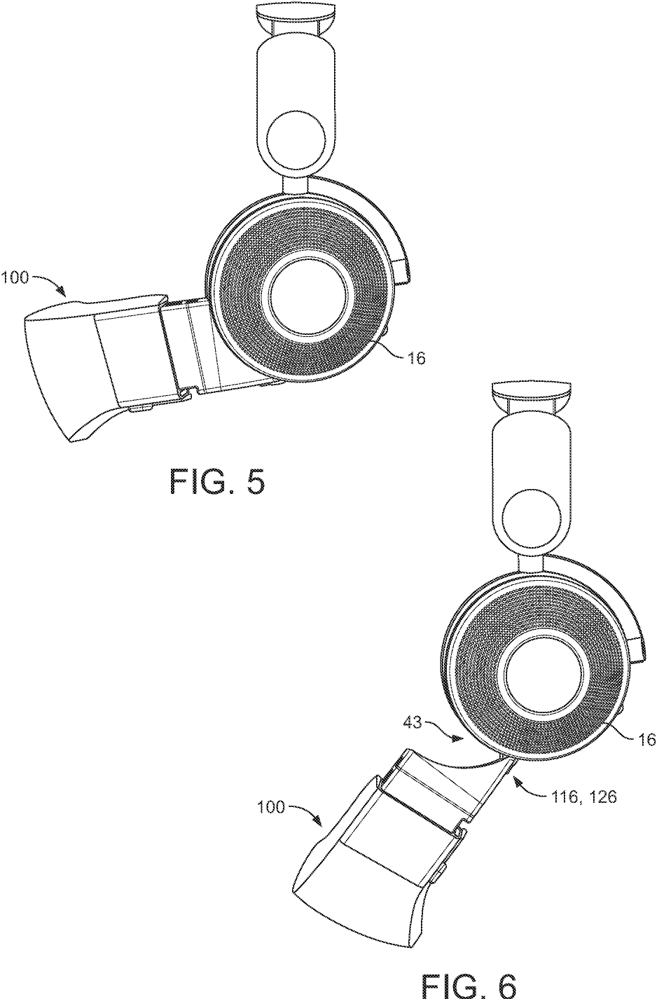

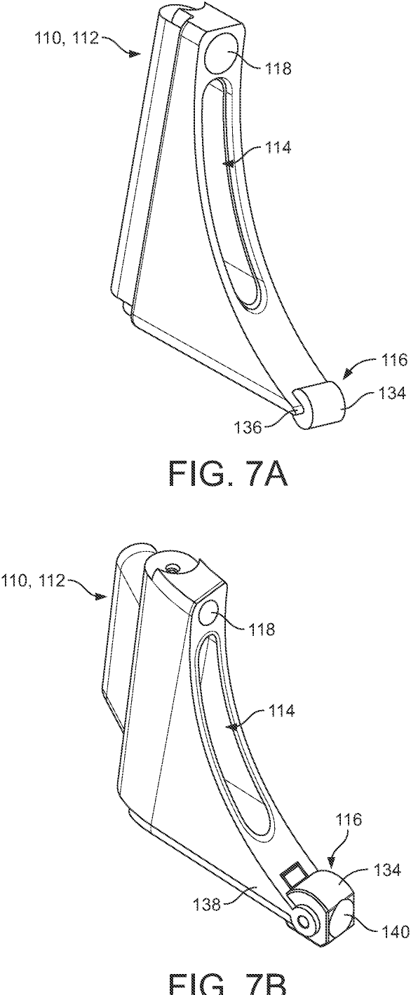

The connector portions 110, 112 comprise magnetic hinges 116 and magnetic detents 118 that respectively rotatably connect and retain the conduit 102 relative to the first 14 and second 16 housings. To this end, each of the first 14 and second 16 housings comprise respective upper 124 and lower 126 magnets, with the upper magnets 124 located to engage the magnetic detents 118, and the lower magnets 126 located to engage the magnetic hinges 116. Further details of the magnetic hinges 116 will be described hereafter, but as is clear from FIGS. 5 and 6 the magnetic hinges 116 enable the nozzle assembly 100 to rotate relative to the first 14 and second 16 housings. In particular, the nozzle assembly 100 is rotatable about the magnetic hinges 116 between a first configuration, shown in FIG. 5, and a second configuration, shown in FIG. 6.

In the first configuration of FIG. 5, the nozzle assembly 100 is fully connected to the first 14 and second 16 housings and is held in place by the engagement of the upper magnets 124 with the magnetic detents 118 and the magnetic hinges 116 with the lower magnets 126. The inlet apertures 114 of the first 110 and second 112 connector portions of the conduit 102 are substantially aligned with, and coincident with, the outlet apertures 43 provided by the respective first 14 and second 16 housings. When filtered airflow is provided by the airflow generators 44, it is able to pass through the outlet apertures 43, into the inlet apertures 114, and then flow through the conduit 102 to the air outlet 120 where it is provided to the wearer.

In use, in the first configuration, the wearable air purifier 10 is located on a head of a wearer such that the first 14 and second 16 housings are located over an ear of the wearer, and the nozzle assembly 100 extends in front of a mouth and lower nasal region of the face of the wearer, without contacting the face of the wearer. The airflow generators 44 are actuable to draw air through the ambient air inlet 40 provided by each of the first 14 and second 16 housings, through the filter assemblies 42, and expel filtered airflow through the outlet apertures 43 into the inlet apertures 114 of the first 110 and second 112 connector portions of the conduit 102. Filtered airflow travels through the conduit 102 as first and second filtered airflows, and is delivered from the nozzle assembly 100, via the air outlet 120, to the wearer of the wearable air purifier 10. The speaker assemblies 32 may provide audio data to a user, for example in the form of music and the like, and alternatively or additionally may provide noise cancellation for noise caused by operation of the airflow generators 44.

Although depicted here with two airflow generators 44, each feeding one end of the nozzle assembly 100, it will be appreciated that in alternative embodiments only a single airflow generator 44 may be provided, which may either feed both or one of the ends of the nozzle assembly 100.

When it is desired to move the nozzle assembly from the first configuration of FIG. 5 to the second configuration of FIG. 6, a wearer can manually rotate the nozzle assembly about the magnetic hinges 116, against and overcoming the force of attraction between the magnetic detents 118 and the upper magnets 124, such that the nozzle assembly 100 rotates downwardly relative to the wearer (i.e. in a plane parallel to a sagittal plane of a wearer), thereby increasing the angle between the nozzle assembly 100 and the first 14 and second 16 housings of the headgear. In the second configuration of FIG. 6, the nozzle assembly 100 is only partially connected to the first 14 and second 16 housings with the inlet apertures 114 spaced apart from, and misaligned with, the outlet apertures 43, such that no filtered airflow passes through the conduit 102 to the wearer.

In some embodiments, a sensor 128, an airflow generator controller 130, and a speaker assembly controller 132 are provided in at least one of the first 14 and second 16 housings (shown schematically in the first purifier assembly housing 14 in FIG. 3). For example, the sensor 128 may be a Hall sensor that is configured to sense the magnetic detent 118 of a connector portion 110, 112 of the nozzle assembly 100. As an alternative example, the sensor 128 may be a contract switch that is closed when a connector portion 110, 112 of the nozzle assembly 100 is fully connected to the respective housing 14, 16. When the sensor 128 detects movement of a connector portion 110, 112 away from the respective housing 14, 16, the sensor 128 communicates with the airflow generator controller 130 which controls both airflow generators 44 to stop the generation of airflow. This may provide power saving by preventing operation of the airflow generators 44 when the nozzle assembly 100 is not in a position to provide filtered airflow to the wearer, i.e. when the nozzle assembly 100 is in the second configuration. Furthermore, when the sensor 128 detects movement of a connector portion 110, 112 away from the respective housing 14, 16, the sensor 128 communicates with the speaker assembly controller 132 which controls both speaker assemblies 32 to pause or stop generation of audio content and/or noise/cancellation effects. Again, this may provide a power saving by inhibiting operation of the speaker assemblies 32 when the nozzle assembly 100 is in the second configuration, for example dipped when a wearer intends to talk.

Although shown here as having a single sensor 128, it will be appreciated that two sensors 128 may be provided, one for each end of the nozzle assembly 100. It will further be appreciated that the sensor data may cause the controllers 130, 132 to control operation of one or more of the respective airflow generators 44 and speaker assemblies 32. The airflow generator controller 130 may automatically control the airflow generators 44 in response to detection of the first configuration of the nozzle assembly, or a user input may be required to start airflow generation. It will further be appreciated that appropriate wired and/or wireless communications may be provided between the sensor 128 and the controllers 130, 132, or between the controllers 130, 132 and the airflow generators 44 and speaker assemblies 32, and that any appropriate form of sensor 128 that is capable of detecting whether the nozzle assembly 100 is in the first or second configurations may be utilised.

The connection between the nozzle assembly 100 and the housings 14, 16 is provided by hinges such that the nozzle assembly 100 is rotatable relative to the housings 14, 16, and it will be appreciated that any hinged connection may be provided. In embodiments described herein, the hinges are magnetic hinges 116, which are fixedly attached to the connector portions 110, 112 of the nozzle assembly 100, and releasably attached to the respective first 14 and second 16 housings via the lower magnets 126. Such a releasable connection may allow for complete removal of the nozzle assembly 100 from the first 14 and second 16 housings, which may allow for ease of cleaning of the nozzle assembly 100 and may allow for the wearable air purifier to be used as conventional headphones when the wearer does not require a supply of filtered air.

It will be appreciated that the strength of attachment between the magnetic hinges 116 and the lower magnets 126 may be greater than the strength of attachment between the magnetic detents 118 and the upper magnets 124, such that rotation about the magnetic hinges 116 is enabled without inadvertent removal of the nozzle assembly 100 in use.

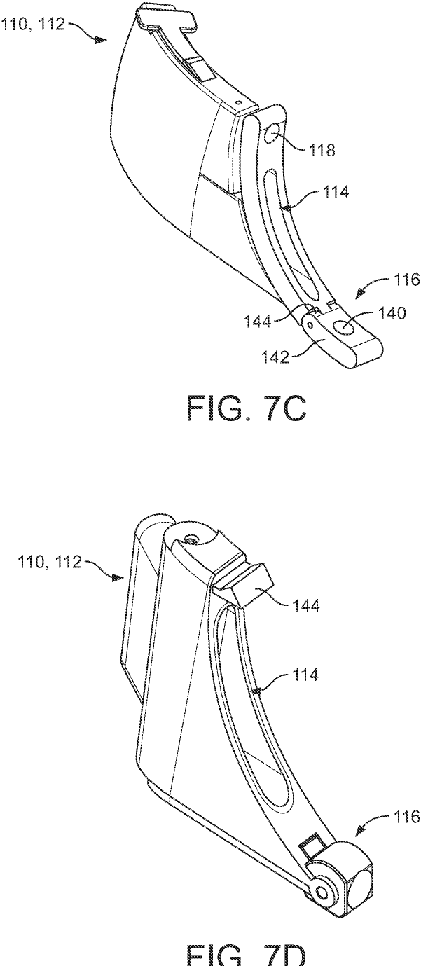

Examples of appropriate magnetic hinges can be seen in FIGS. 7a-7c.

In the embodiment of FIG. 7a, each magnetic hinge 116 comprises a cylindrical barrel portion 134 rotatably mounted onto a pin or axle 136. The pin 136 is fixedly attached to the respective connector portions 110, 112 of the nozzle assembly 100, whilst the barrel portion 134 is formed of a magnetic material and selectively attachable to the lower magnets 126 of the first 14 and second 16 housings of the headgear.

In the embodiment of FIG. 7b, each magnetic hinge 116 comprises a barrel portion 134 rotatably mounted to the respective connector portion 110, 112 of the nozzle assembly 100 by a fork arrangement 138, with the barrel portion 134 comprising a magnet 140 for attachment to the lower magnet 126 of the housings 14, 16. The rotatable connection between the fork arrangement 138 and the barrel portion 134 enables the nozzle assembly 100 to rotate relative to the housings 14, 16, whilst the magnet 140 of the barrel portion 134 enables selective connection of the nozzle assembly 100 to the housings 14, 16.

In the embodiment of FIG. 7c, each magnetic hinge 116 comprises a leaf portion 142 rotatably attached to a knuckle 144 of the connector portion 110, 112, with the leaf portion 142 comprising a magnet 140 for attachment to the lower magnet 126 of the housings 14, 16. The rotatable connection between the leaf portion 142 and the knuckle 144 enables the nozzle assembly 100 to rotate relative to the housings 14, 16, whilst the magnet 140 of the leaf portion 142 enables selective connection of the nozzle assembly 100 to the housings 14, 16.

In the embodiments described herein, a rotational extent of the magnetic hinge 116 may be limited such that motion of the nozzle assembly 100 relative to the housings 14, 16 about the magnetic hinge 116 is limited. This may be achieved in any appropriate way, for example by controlling rotation or by providing a stop member that prevents over-rotation of the magnetic hinge 116.

In the embodiments described herein the magnetic attachments between the nozzle assembly 100 and the housings 14, 16 of headgear are achieved through cooperation between magnets 118, 140 provided on the connector portions 110, 112 of the nozzle assembly 100 and magnets provided on the housings 14, 16. However it will be appreciated that in alternative embodiments the magnetic attachments between the nozzle assembly 100 and the housings 14, 16 of headgear may be achieved through cooperation of magnets (i.e. permanent magnets) provided on one or other of the connector portions 110, 112 and the housings 14, 16 and magnetic material (i.e. that is magnetically attracted to a magnet) provided on the other of the connector portions 110, 112 and the housings 14, 16.

It will also be appreciated that in some embodiments a mechanical catch mechanism may act to releasably retain the nozzle assembly 100 relative to the first 14 and second 16 housings as an alternative, or in addition to, the magnetic detents 118. For example, as shown in FIG. 7d, a catch in the form of a cantilevered hook 144 is located on the connector portion 110, 112 for releasably engaging a catch keeper in the form of a mating feature (not shown), such as a recess or loop, provided on the respective housing 14, 16. The cantilevered hook 144 is sufficiently flexible to enable release of the hook 144 from the mating feature by a wearer, whilst preventing inadvertent release.

Furthermore, in the illustrated embodiments the filter assemblies 42 and airflow generators 44 of the air purifier assembly are housed within the housings 14, 16 of the headgear (i.e. that form the earcups), and are therefore integral/built-in to the headgear such that the ambient air inlets 40 and outlet apertures 43 of the air purifier assembly are provided by these housing 14, 16. However, it will be appreciated that in some embodiments the filter assemblies 42 and airflow generators 44 of the air purifier assembly may be housed within their own distinct purifier assembly housings, with the ambient air inlets and outlet apertures of the air purifier assembly then being provided by these purifier assembly housings.

In such embodiments, the purifier assembly housings then may or may not be supported by the headgear. For purifier assembly housings that are supported by the headgear, the nozzle assembly may be directly connected to the outlet apertures of the air purifier assembly by the hinges, such that the nozzle assembly is indirectly connected to the headgear. Alternatively, the nozzle assembly may be directly connected to the headgear by the hinges and fluidically connected to the outlet apertures of the air purifier assembly by ducting that is connected to the headgear. For purifier assembly housings that are not supported by the headgear, and are instead worn elsewhere on the body of wearer (e.g. on a belt or around the neck of the wearer), the nozzle assembly may be directly connected to the headgear by the hinges and fluidically connected to the outlet apertures of the air purifier assembly by ducting that is connected to the headgear.

1. A wearable air purifier comprising:
a headgear;
an air purifier assembly, the air purifier assembly configured to generate a filtered airflow from an outlet aperture thereof; and
a nozzle assembly connected to the headgear by a hinge assembly, the nozzle assembly comprising an inlet aperture for receiving the filtered airflow from the outlet aperture of the air purifier assembly and an air outlet for emitting the filtered airflow from the nozzle assembly,
wherein the hinge assembly is configured such that the nozzle assembly is movable relative to the headgear between first and second configurations, filtered airflow is emitted from the air outlet in the first configuration, and filtered airflow is not emitted from the air outlet in the second configuration.

2. The wearable air purifier as claimed in claim 1, wherein filtered airflow generated by the air purifier assembly is received by the inlet aperture of the nozzle assembly when the nozzle assembly is in the first configuration.

3. The wearable air purifier as claimed in claim 1 , wherein filtered airflow generated by the air purifier assembly is not received by the inlet aperture of the nozzle assembly when the nozzle assembly is in the first configuration.

4. The wearable air purifier as claimed in claim 1 , wherein the inlet aperture of the nozzle assembly is in fluidic communication with the outlet aperture of the air purifier assembly when the nozzle assembly is in the first configuration.

5. The wearable air purifier as claimed in claim 1 , wherein the inlet aperture of the nozzle assembly is not in fluidic communication with the outlet aperture of the air purifier assembly when the nozzle assembly is in the second configuration.

6. The wearable air purifier as claimed in claim 1 , wherein the nozzle assembly is connected to the headgear by the hinge assembly such that the nozzle assembly moves away from the headgear when moving from the first configuration to the second configuration.

7. The wearable air purifier as claimed in claim 1 , wherein the nozzle assembly is retained in the first configuration by a detent.

8. The wearable air purifier as claimed in claim 7 , wherein the detent comprises a first magnetic element and a second magnetic element that cooperates with the first magnetic element to releasably retain the nozzle assembly in the first configuration.

9. The wearable air purifier as claimed in claim 7, wherein the detent comprises a catch and a catch keeper that cooperates with the catch to releasably retain the nozzle assembly in the first configuration.

10. The wearable air purifier as claimed in claim 1 , wherein the hinge assembly comprises first and second portions rotatably connected to one another, the first portion fixedly connected to one of the nozzle assembly and the headgear, and the second portion releasably connected to the other of the headgear and the nozzle assembly.

11. The wearable air purifier as claimed in claim 1 , wherein the nozzle assembly comprises a first end connected to a first end of headgear by a first hinge, and a second opposite end connected to a second opposite end of the headgear by a second hinge.

12. A wearable air purifier comprising:
a headgear;
an air purifier assembly, the air purifier assembly configured to generate a filtered airflow; and
a nozzle assembly comprising an inlet aperture for receiving the filtered airflow from the air purifier assembly, and an air outlet for emitting the filtered airflow from the nozzle assembly;
wherein the nozzle assembly is rotatably connected to the headgear by a hinge assembly and the wearable air purifier comprises a releasable detent that inhibits rotation of the nozzle assembly relative to the headgear until the detent is released.

13. The wearable air purifier as claimed in claim 12, wherein the nozzle assembly is connected to the headgear by the hinge assembly such that the nozzle assembly moves away from the headgear from a first configuration to a second configuration when the detent is released.

14. The wearable air purifier as claimed in claim 12 , wherein the nozzle assembly is movable relative to the headgear in a plane parallel to a sagittal plane of a wearer in use.

15. The wearable air purifier as claimed in claim 12 , wherein the detent comprises a first magnetic element and a second magnetic element that cooperates with the first magnetic element to releasably inhibit rotation of the nozzle assembly relative to the headgear.

16. The wearable air purifier as claimed in claim 12 , wherein the detent comprises a catch and a catch keeper that cooperates with the catch to releasably inhibit rotation of the nozzle assembly relative to the headgear.

17. The wearable air purifier as claimed in claim 12 , wherein the hinge assembly comprises first and second portions rotatably connected to one another, the first portion fixedly connected to one of the nozzle assembly and the headgear, and the second portion releasably connected to the other of the headgear and the nozzle assembly.

18. The wearable air purifier as claimed in claim 12 , wherein the nozzle assembly comprises a first end connected to a first end of the headgear by a first hinge, and a second opposite end connected to a second opposite end of the headgear by a second hinge.
